(19) United States
(12) Patent Application Publication
(10) Pub. No.: US 2009/0313083 A1
(43) Pub. Date: Dec. 17, 2009

(54) RENEWABLE ENERGY CALCULATOR

(75) Inventors: Jim Dillon, Coopersburg, PA (US); Ronald Blagus, Sylvania, OH (US); Stephen Parr, Burlington, CT (US); Venkat Iyer, Iselin, NJ (US); Alan Houghton, Providence, RI (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/138,753

(22) Filed: Jun. 13, 2008

(51) Int. Cl. G06Q 10/00; G06Q 50/00; G06Q 40/00

(52) U.S. Cl. 705/10; 705/7; 705/35

(57) ABSTRACT

A calculator or system for evaluating renewable energies in various geospatial areas or regions and for targeting potential buyers. The calculator may have a financial model which has inputs of renewable energy data by region including respective energy outputs and monetary values. The inputs may also include financial information related to establishing renewable energies. An output from the financial model may include a scorecard of information. Also, customer information may be added to the scorecard. The scorecard may have an output that targets potential customers of renewable energies.

### BACKGROUND

The present invention pertains to energy and particularly to renewable energy. More particularly, the invention pertains to assessment of renewable energies.

### SUMMARY

The present invention is a calculator or an approach for assessing and evaluating renewable energies. Further, it may be for determining whether a renewable energy is practicable in a particular region and which entities may be buyers and/or users of the energy.

### BRIEF DESCRIPTION OF THE DRAWING

FIG. 1 is a diagram of a renewable energy calculator or system for calculation;

FIGS. 2a-2c are tables of conventional energy rates, local attributes related to weather and government incentives, sources of renewable energy for several particular areas;

FIGS. 3a-3c are graphs showing a potential for renewable energy in the particular areas;

FIGS. 4a-4c are graphs showing an economic benefit per an amount of investment and payback years for an investment for renewable energies in the particular areas; and

FIGS. 5a-5c are graphs showing a comparison of renewable energy rates with conventional energy rates.

### DESCRIPTION

With an ever-expanding global population with rising oil prices, increasing environmental concerns over traditional energy resources such as coal, apparent evidence of global warming, and a growing consciousness of a need to find energy alternatives, “green energy” has become seemingly noteworthy. Here, “green energy” may be regarded as “renewable energy”.

Renewable energy resources may include technologies such as photovoltaic and thermal solar power, wind power, biomass thermal and gasification, geothermal, and biofuels. Many environmentally conscious companies and institutions, along with considerable federal and state mandates, incentives, and tax credits may push these technologies forward and make them not only environmentally safe, but economically feasible.

A foremost core challenge is not just making the renewable project economically feasible, but rather effectively identifying the best renewable energy technology for an entity, potential buyer or buyer, potential customer or customer, or the like, and drawing maximum benefits from the technology. The solution may vary depending on customer type, geographic location, government incentives, and so forth.

In response to this challenge, the present approach may introduce an encompassing renewable energy profiling model that allows one to accurately and seamlessly direct customers to renewable energy solutions that will bring maximized economic return. Finding the renewable technology that makes the best environmental and business sense may be regarded as a core element of the profiling model. The model may allow one to find the markets which are good for specific renewable energy technologies that provide strong economic drivers for its customers.

The present invention is a calculator using the profiling model having an approach for determining applicable target markets to direct a sales/marketing campaign for a technology based product or system. The calculator may support evaluating target markets for renewable energy solutions to focus sales and marketing resources on opportunities where the subject renewable energy source (e.g., fuel, sun, wind, geothermal or other) is available and the geospatial areas or regions where there are sufficient resources and loads to warrant use of renewable energy. The present system may enable one to focus just in the areas where the renewable energy technology is available and a valid financial justification can be generated.

The present calculator may be used to direct sales forces in an efficient manner by focusing renewable energy campaigns primarily in the geographical areas where a financially viable project can be structured. Output from the calculator may be used directly in a sales campaign to show a prospective customer the financial value of the different renewable energy technologies, so the customer can see in terns of energy production and financial return on investment, which renewable technologies are best for the customer's situation. The calculator may combine several key sources of information including energy output of the technology, prevailing energy rates, market size and energy load factors on an area basis (i.e., a county in the U.S. or census district in Canada) in order to build a comprehensive country-wide model for each renewable energy technology.

The renewable energy profiling model may be used to basically model imperative variables of a renewable energy project for nearly each area in North America. The model may enable calculations to note which renewable markets are viable and beneficial for a given customer. There may be a number of ways to finance energy projects for customers, including performance contracts and power purchase agreements (PPAs), along with other ways of financing. A PPA is where a party providing the service owns the asset and sells the power to the customer or client.

The profiling model may enable one to lead customers directly to the technologies that will offer the strongest economic drivers, and provide optimum advantages for customers who are not only motivated by environmental stewardship but also by economic value. As early as a first call with a customer or upon receipt of a request for price submittal; by using the present profiling model, one may almost immediately offer informed, data-driven information about what good economic drivers there are for the different renewable energy technologies. With the model, one may be able to look at information about a particular customer and determine what the simple expected paybacks would be for different types of renewable energy solutions reasonably available before talking to the customer.

Access to an extensive amount of research and data may be needed to construct the present profiling model, and thus offer customers options and help them identify the technologies that would make the most environmental and economic sense to them. In order to isolate where the actual markets are for the varying renewable technologies, one may need to know a number of different variables. These variables may include local electricity and gas prices, heating and cooling degree days, available grants, subsidies and rebates, tax implications and deal structures, a capital purchase versus a performance contract versus a power purchase agreement, citing permissible processes, vendor selection, risk management, and other variables as appropriate. One may examine these variables and then model them against a collected database of such variables for counties and districts across the North American continent.

The database may give an accurate vision and analysis of many energy projects and customers, at various locations. One may provide not only an expertise prognosis of which renewable energy technology a customer should use given a set of variables, but also a relatively accurate financial forecast derived from extensive and intricate particulars such as tax implications, rebates, subsidies, and other incentives that the present profiling model calculates.

So when a customer comes with an inclination to implement photovoltaic solar panels and add them to its energy portfolio, rather than going along with the customer's inclination, one may pose a direct question crucial to any customers' bottom line, “Do you want to go solar, or do you want to go green?” And if the customer says “green,” one may then demonstrate that with the present calculator, the homework has already been done by showing more or less six different renewable energy technologies and the paybacks for each one. This tends to eliminate error in choosing the wrong renewable energy technology and to maximize efficiency and benefits of a favorable technology. No sales pitch, just data driven solutions may be presented in the first interaction with the customer.

After one has utilized the present calculator to provide a renewable energy profiling model, then a renewable energy scorecard may be issued for the customer. The scorecard may provide a full-range look at the different types of renewable energy resources available to the customer along with physical and financial modeling parameters for each technology. The scorecard may take on a form of a spreadsheet. It may also have information in the form of charts and graphs. From information for the scorecard, the calculator may quickly illustrate and evaluate the financial impact of several renewable technologies. Results form the calculator may be placed or displayed in the scorecard. The scorecard may be a pro form a business model showing economic opportunity.

A strategic decision to utilize a particular technology may be a result of the present renewable energy technology profiling model of the calculator which highlights the crucial variables such as local electric and gas prices, heating and cooling degree days, costs, comparisons, available grants, subsidies, rebates, tax implications, and deal structures, among other significant factors. The renewable energy scorecard of the calculator for a renewable energy project may be illustrated by the following.

Financial modeling parameters may include the following items provided for a scorecard. Payback may equal project price minus gross income. Gross income may be subtracted yearly from the project price as a declining balance until the project price equals zero. Economic benefit savings per one million dollars may equal gross income divided by project price. The average of the first ten years of gross income (discounted at 3 percent) may be divided by project price. A conventional electric rate may be the state average utility electric price delivered to the meter as obtained from the U.S. Department of Energy's Energy Information Agency database.

A conventional gas rate may be the state average utility gas price delivered to the meter as obtained from the EIA database. The renewable energy rate (in view of a power purchase agreement (PPA) in place) may be the price per kWh that a customer would pay for the electricity produced by a power generating asset (solar PV and/or wind turbines, and so on) for the duration of the agreement. This arrangement may be provided in lieu of a direct capital purchase of the power generating asset or assets. There typically tends to be no other charges for the term of the PPA. This rate may be escalated at, for instance, 2.5 percent from year 1 on for 20 years in this model. The rate may generally be inclusive of taking available rebates, performance credits (e.g., renewable energy credits) and depreciation.

The types of renewable energy sources included in the present profiling model may include the following items. Solar photovoltaic (PV) may include using solar energy through photovoltaic panels to generate electricity. Solar thermal (therm) may include using solar energy to generate hot water for domestic and heating uses in lieu of a natural gas, propane, coal-fired or electric domestic hot water heater or boiler. Wind power may include using wind energy through wind turbines to generate electricity. Biomass thermal (therm) may include using woody carbon containing materials, such as forest clearing waste, mill residue and urban wood waste, and the like, in a combustion or gasification process to generate steam or hot water for domestic and heating hot water use.

Biomass electricity generation (biomass gen) may appear to be the same basic technology as biomass thermal; but instead of displacing a thermal domestic or heating load, it may provide a steam output to make electricity through a turbine and generator. Geothermal may use the earth's temperature through heat pumps for heating and cooling.

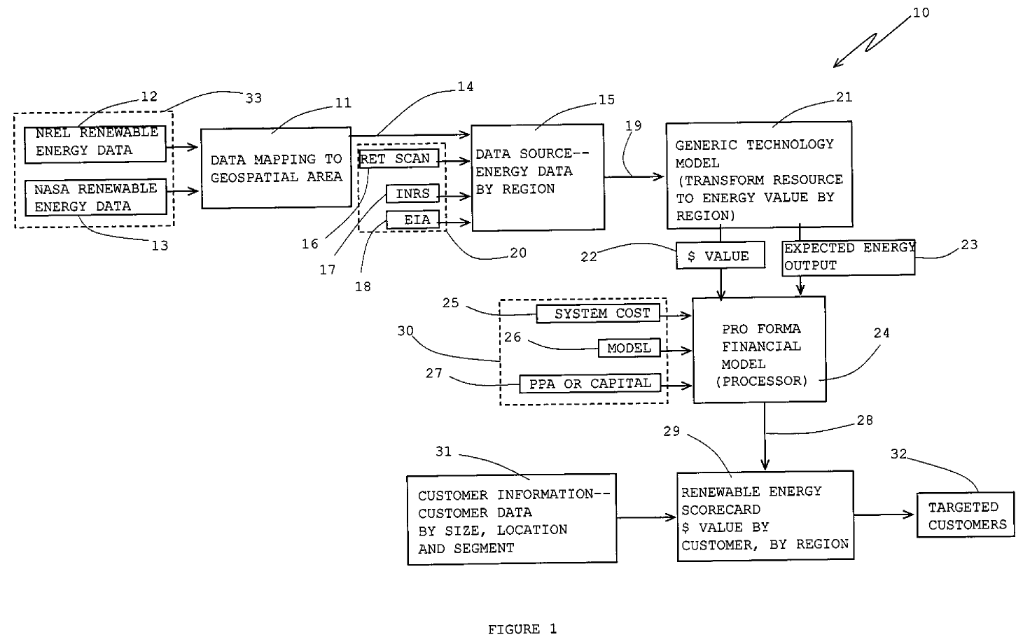

FIG. 1 is a block diagram that shows key inputs, outputs and approaches of a renewable energy calculator or system for calculation. Key public domain data sources may be used as input to obtain data on renewable energy availability, fuel costs/rates, and weather information. Data may be mapped geographically to convert the energy available into an energy value per geographic region or area. The energy value may be run through a pro form a financial model calculation to determine the financial viability of using a certain renewable energy source in a specific geographic region. Customer lists by market segment may then be compared against the pro form a calculation to determine what customers in what regions are candidates for a specific renewable energy source. Various filters, such as size, cost, or scale, may be used to select the customer data set.

For specific customer sales opportunities, a scorecard may be generated that illustrates the financial value proposition of each renewable energy technology at the customer's location. One may discuss with a potential customer an energy services contract. The customer may have an interest in using renewable energy technologies as part of the contract. One may contact an energy marketing department or firm to obtain a scorecard for the customer's site/location. A renewable energy scorecard for the customer's location may show the financial return on investment of each of the renewable energy technologies, including wind, solar PV, solar thermal, geothermal, biomass thermal and biomass generation.

Another use of the present energy calculator may include developing sales leads in support of a specific renewable energy technology in a specific geographic area. For example, one may use the present calculator to develop specific sales leads for customers in a geographic region that has high potential for the particular renewable energy source under consideration. The present calculator may be used in support of solar initiative in a specific selected U.S. county. The calculator may be used to develop, for instance, a list of municipalities and school districts within the county having the right characteristics, such as cost of electricity, solar energy, and so forth, favorable to a solar PV energy solution.

A flow diagram of the present system or calculator 10 is shown in FIG. 1. A module 11 may provide data mapping to a geospatial area from inputs such as NREL renewable energy data 12 and NASA renewable energy data 13. Data 12 may include such items as solar, wind, biomass and geothermal energy amounts for various geospatial areas such as counties and census districts. Data 13 may include local attributes of various areas such as heating and cooling degree days, average temperature, and so forth. Data 13 are pertinent to renewable energy situations. Data 12 and 13 sources may be regarded as a renewable energy data module 33. NREL refers to the National Renewable Energy Laboratory. An output 14 of module 11 may be an input to a module 15 for putting together a data source for energy data by region to be entered in a scorecard. An input from a RET scan 16, input from INRS 17 and input from EIA 18 may also go to module 15. RET scan 16, INRS 17 and EIA 18 may be regarded as renewable energies information source 20. RET refers to renewable energy technologies; INRS refers to innovative natural resource solutions; and EIA refers to energy information administration.

An output of module 15 may be data 19 having renewable energy information for a scorecard for a specific region. Data 19 may be input to a module 21 which is for providing a generic technology model. Module 21 may transform data 19 to an energy value by region. An output 22 may provide a dollar value of a technology model and output 23 may provide an expected energy output of the respective model. Outputs 22 and 23 may go to a module 24 which may provide a pro form a financial model. Module 24 may also contain a processor. Other inputs to module 24 may include renewable energy system cost 25, finance model 26, and PPA or capital information 27, respectively, which can be regarded as a finance information module 30. Model 30 may have information for such items as payback in years, rate of return, renewable energy asset ownership, selling renewable energy, various financing arrangements, and so on. An output 28 of module 24 may provide the pro form a financial model to a scorecard module 29. A customer information module 31 may provide customer data by size, location and segment to module 29. Module 29 may have information for certain customers such as a renewable energy scorecard, dollar value by customer, by region and more. With information from module 29, customers 32 may be targeted as good prospects for successful renewable energy projects. The customers 32 may then be shown what they can gain from certain renewable energy approaches.

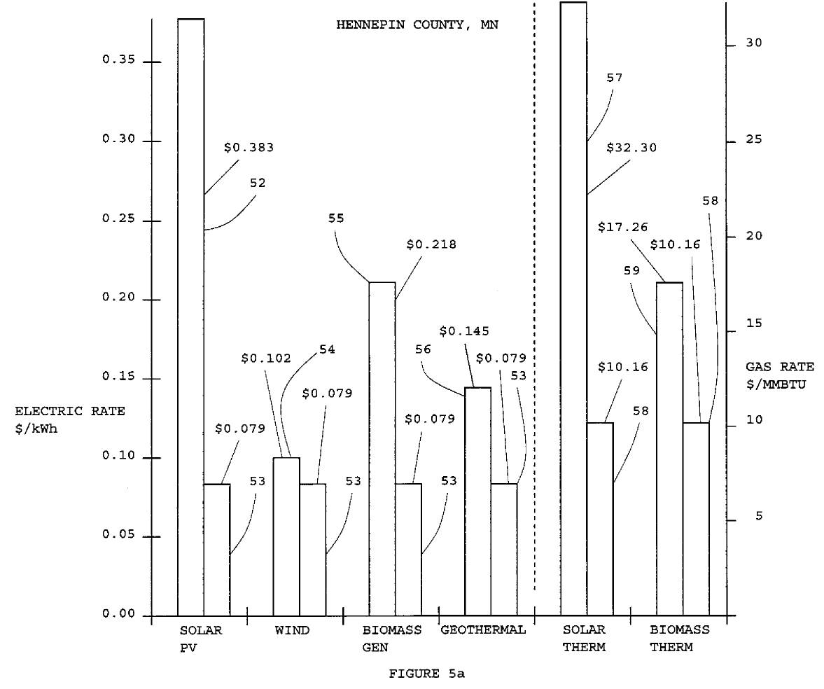

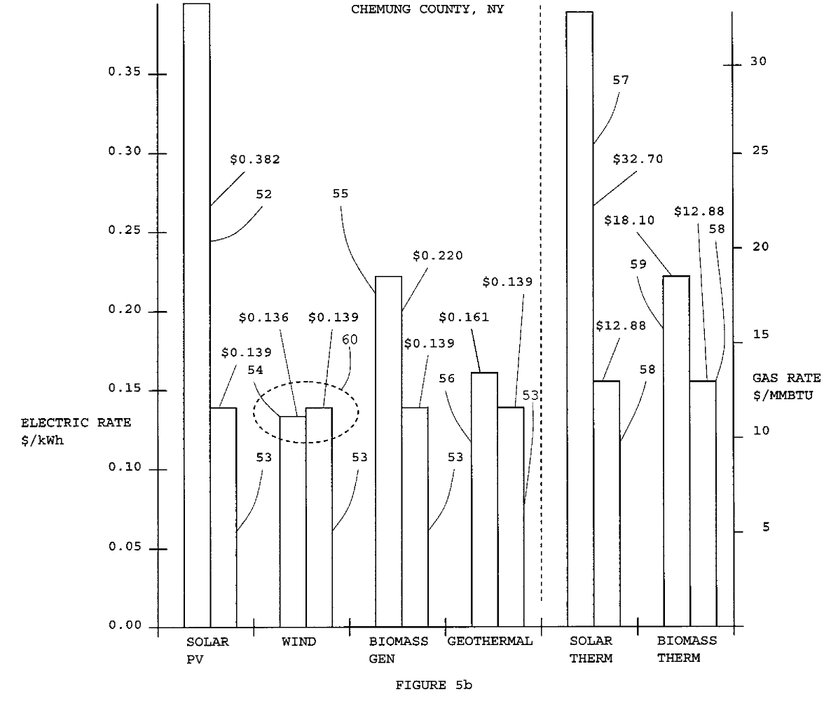

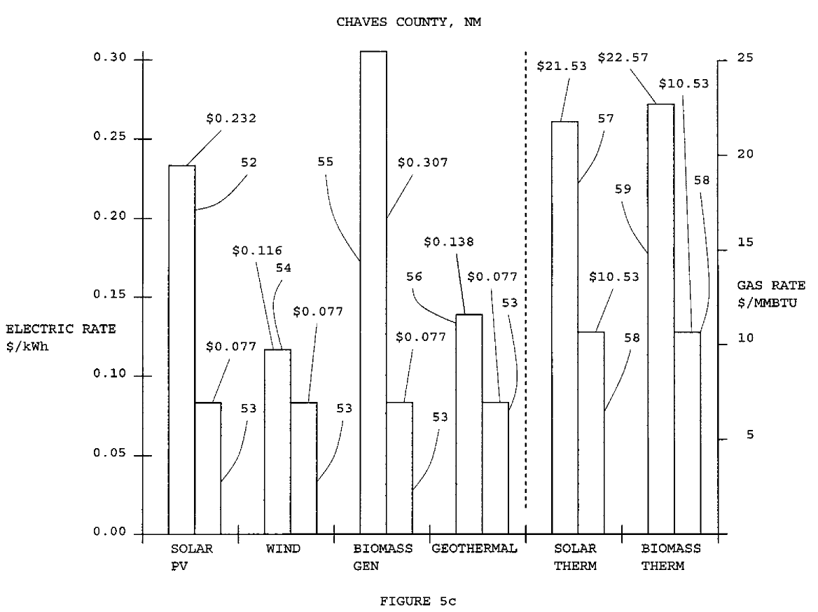

An example primary determination or figure of merit for indicating whether a customer of a specific area or region should be targeted may include a comparison of rates of conventional energy and renewable energy, as shown in FIGS. 5a-5c. An example of a favorable primary determination or figure of merit is shown in FIG. 5b for wind where the cost of wind is less than that of conventional electricity. As indicated by a dashed-line circle 60 in FIG. 5b, the cost of wind energy is shown to be about $0.136 per kWh and the cost of conventional electric energy is shown to be about $0.139 per kWh in Chemung County, N.Y.

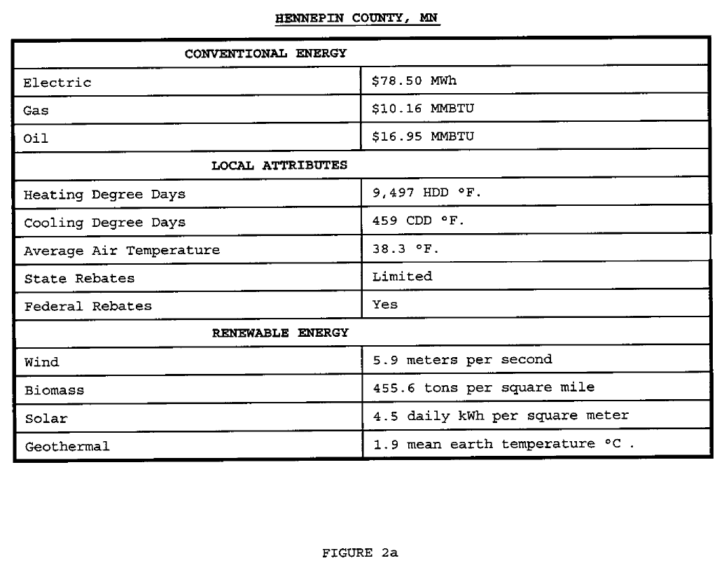

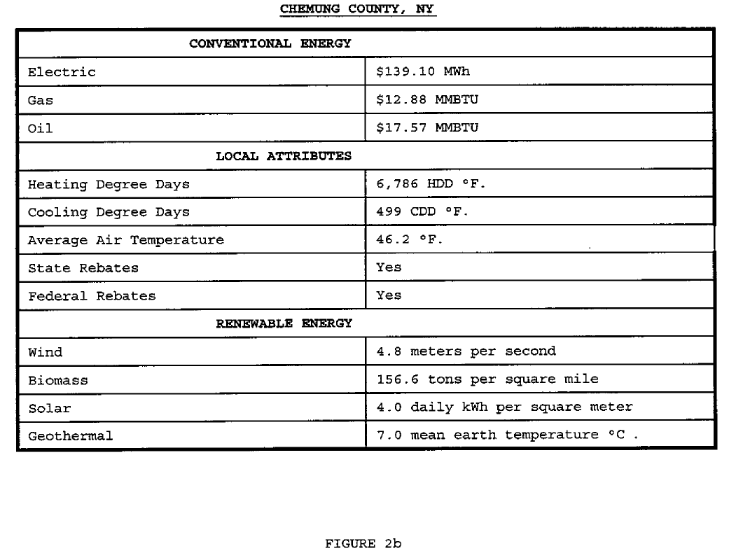

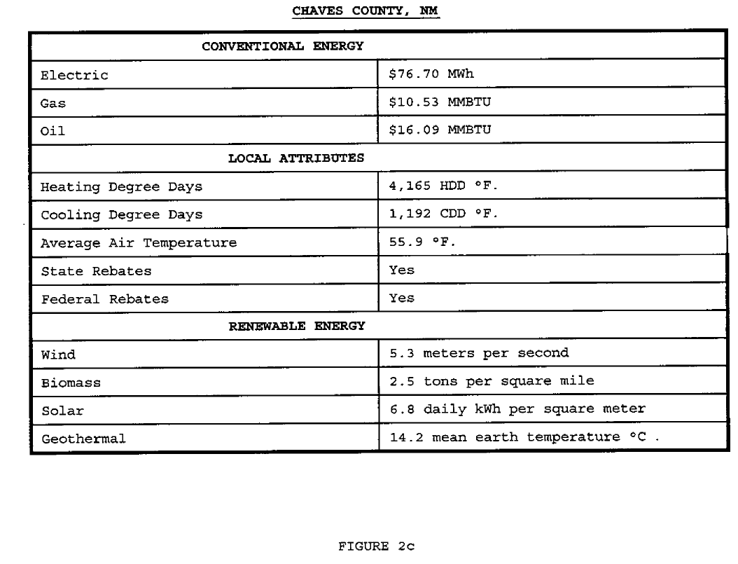

For a customer in a certain region, various kinds of information pertaining to energy may be obtained as shown in tables and graphs of FIGS. 2a-5c. A certain region may be about a county in the U.S. or a census district in Canada. In the U.S., there are over 3,000 counties which may be considered. Such information from diverse areas including the Midwest, East and Southwest may be shown for example counties of Hennepin, Chemung and Chaves in Minnesota, New York and New Mexico, respectively. The table in FIG. 2a may indicate that conventional energy rates for Hennepin County may be about $78.50 per MWh for electricity, $10.16 per MMBTU for gas, and $16.95 per MMBTU for oil. Local weather attributes of the county may include about 9,497 heating degree days, 459 cooling degree days and an average air temperature of 38.3 degrees F. State rebates for renewable energy initiatives may be limited. Federal rebates may be available. Sources of renewable energy in the county may include an average wind speed of about 5.9 meters per second, biomass resources of about 455.6 tons per square mile, and solar energy of about 4.5 daily kWh per square meter. Also, the geothermal source may rely on about 1.9 degrees C. of mean earth temperature.

The table in FIG. 2b may indicate that conventional energy rates for Chemung County may be about $139.10 per MWh for electricity, $12.88 per MMBTU for gas, and $17.57 per MMBTU for oil. Local weather attributes of the county may include about 6,786 heating degree days, 499 cooling degree days and an average air temperature of 46.2 degrees F. State rebates for renewable energy initiatives may be available. Federal rebates may be available. Sources of renewable energy in the county may include an average wind speed of about 4.8 meters per second, biomass resources of about 156.6 tons per square mile, and solar energy of about 4.0 daily kWh per square meter. Also, the geothermal source may rely on about 7.0 degrees C. of mean earth temperature.

The table in FIG. 2c may indicate that conventional energy rates for Chaves County may be about $76.70 per MWh for electricity, $10.53 per MMBTU for gas, and $16.09 per MMBTU for oil. Local weather attributes of the county may include about 4,165 heating degree days, 1,192 cooling degree days and an average air temperature of 55.9 degrees F. State rebates for renewable energy initiatives may be available. Federal rebates may be available. Sources of renewable energy in the county may include an average wind speed of about 5.3 meters per second, biomass resources of about 2.5 tons per square mile, and solar energy of about 6.8 daily kWh per square meter. Also, the geothermal source may rely on about 14.2 degrees C. of mean earth temperature.

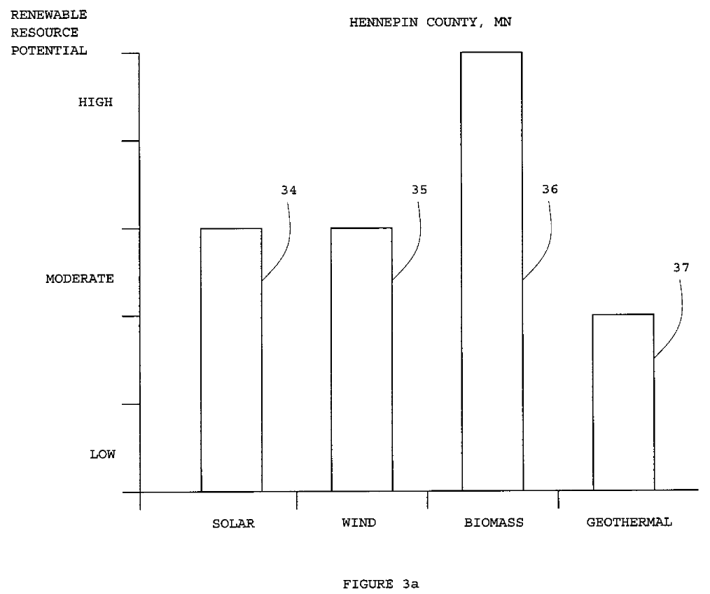

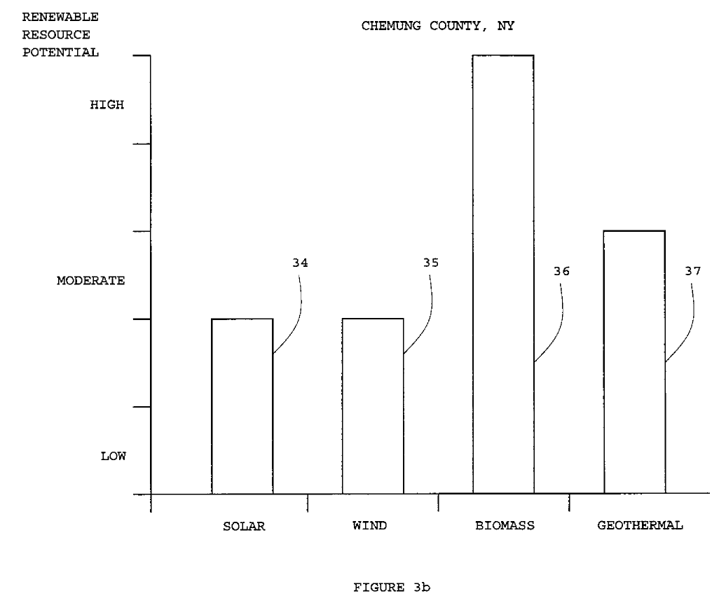

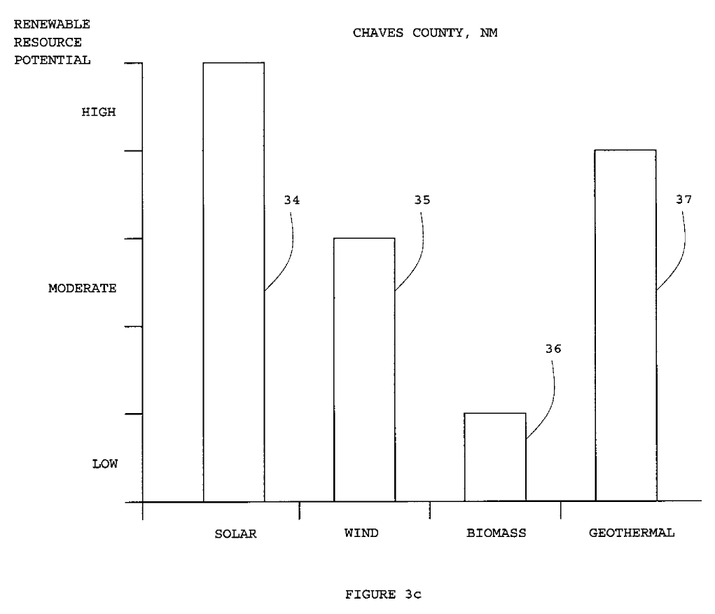

FIG. 3a has a graph which illustrates a relative evaluation of renewable energy resource potential for Hennepin County. Solar and wind potentials may be slightly above moderate as indicated by bars 34 and 35, respectively. The biomass potential may be rather high and geothermal potential may be regarded as nearly moderate as indicated by bars 36 and 37, respectively.

FIG. 3b has a graph which illustrates a relative evaluation of renewable energy resource potential for Chemung County. Solar and wind potentials may be slightly below moderate as indicated by bars 34 and 35, respectively. The biomass potential may be rather high and geothermal potential may be regarded as above moderate as indicated by bars 36 and 37, respectively.

FIG. 3c has a graph which illustrates a relative evaluation of renewable energy resource potential for Chaves County. The solar potential may be rather high and the wind potential may be above moderate, as indicated by bars 34 and 35, respectively. The biomass potential may be rather low and geothermal potential may be regarded as high as indicated by bars 36 and 37, respectively.

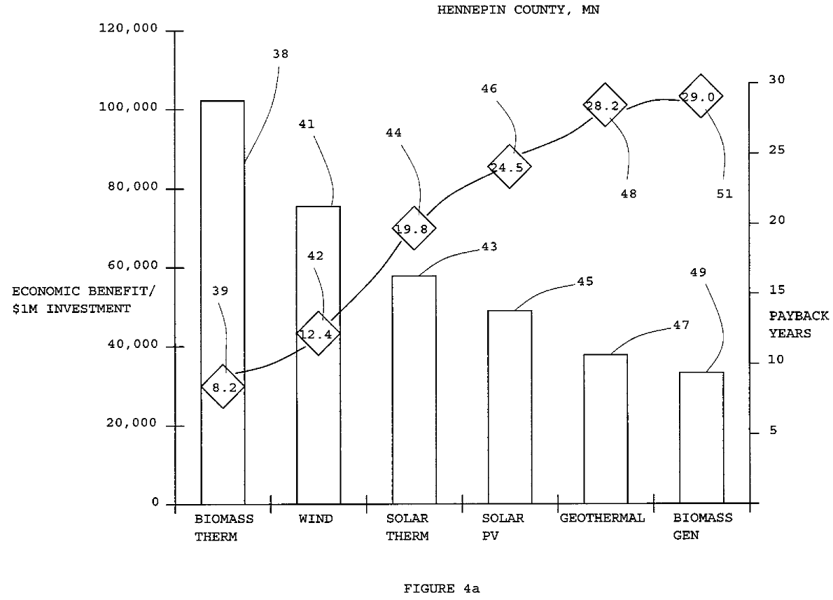

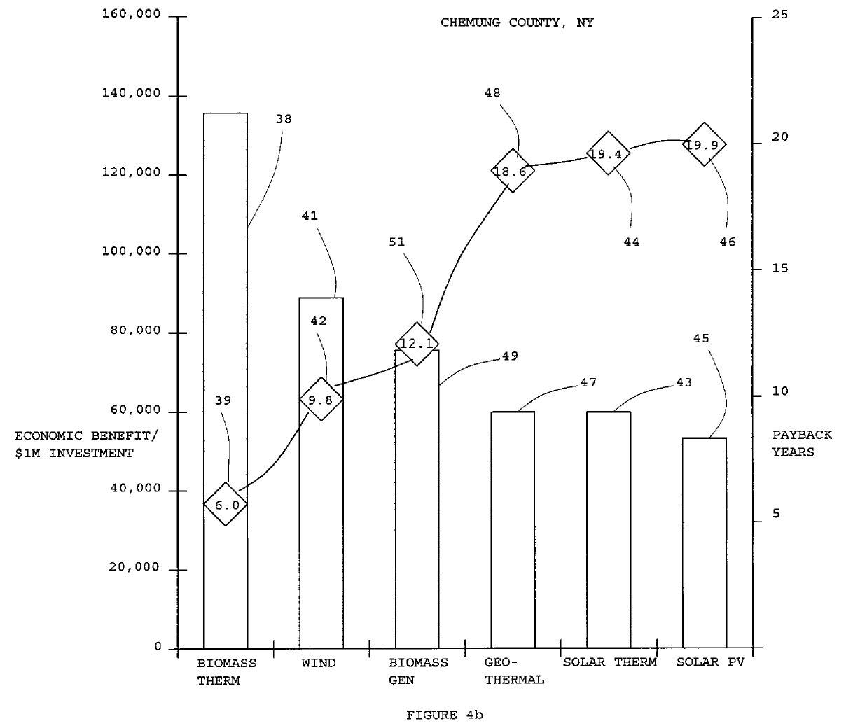

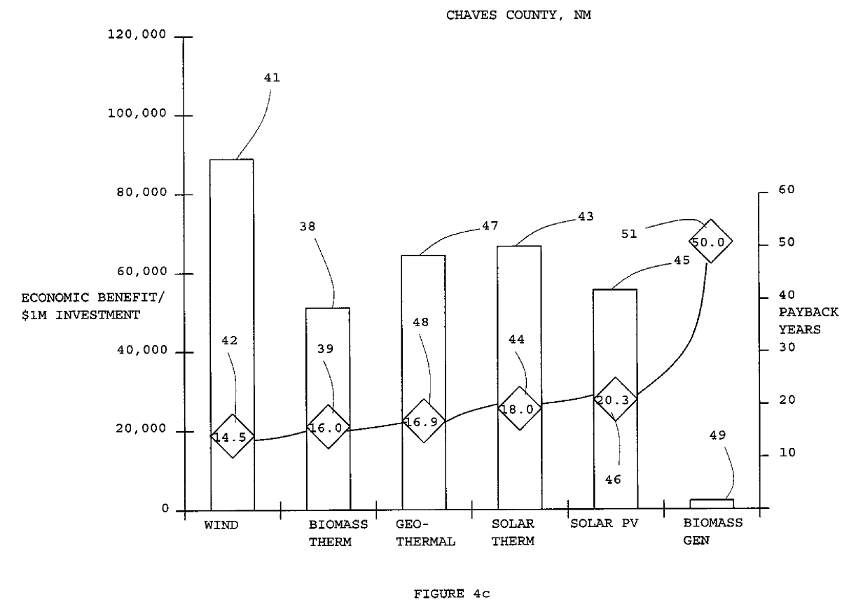

A graph in FIG. 4a shows capital purchase economic benefit per $1 million investment versus a simple payback in terms of years for various renewable energies in Hennepin County. For biomass therm, the benefit may be a little over $100,000 as indicated by bar 38 and the payback in about 8.2 years as indicated by symbol 39. For wind and solar therm, the benefits may be about $75,000 and $57,000 as indicated by bars 41 and 43, and the payback in about 12.4 and 19.8 years as indicated by symbols 42 and 44, respectively. For solar PV and geothermal, the benefits may be about $47,000 and $38,000 as indicated by bars 45 and 47, and the payback in about 24.5 and 28.2 as indicated by symbols 46 and 48, respectively. For biomass gen, the benefit may be about $32,000 as indicated by bar 49, and the payback in about 29 years as indicated by symbol 51.

A graph in FIG. 4b shows capital purchase economic benefit per $1 million investment versus a simple payback in terms of years for various renewable energies in Chemung County. For biomass therm, the benefit may be about $135,000 as indicated by bar 38 and the payback in about 6.0 years as indicated by symbol 39. For wind and biomass gen, the benefits may be about $90,000 and $75,000 as indicated by bars 41 and 49, and the payback in about 9.8 and 12.1 years as indicated by symbols 42 and 51, respectively. For geothermal and solar therm, the benefits may be about $60,000 for each as indicated by bars 47 and 43, and the payback in about 18.6 and 19.4 as indicated by symbols 48 and 44, respectively. For solar PV, the benefit may be about $53,000 as indicated by bar 45, and the payback in about 19.9 years as indicated by symbol 46.

A graph in FIG. 4c shows capital purchase economic benefit per $1 million investment versus a simple payback in terms of years for various renewable energies in Chaves County. For wind, the benefit may be about $70,000 as indicated by bar 41 and the payback in about 14.5 years as indicated by symbol 42. For biomass therm and geothermal, the benefits may be about $51,000 and $65,000 as indicated by bars 38 and 47, and the payback in about 16.0 and 16.9 years as indicated by symbols 39 and 48, respectively. For solar therm and solar PV, the benefits may be about $66,000 and $55,000 as indicated by bars 43 and 45, and the payback in about 18.0 and 20.3 as indicated by symbols 44 and 46, respectively. For biomass gen, the benefit may be less than $2,000 as indicated by bar 49, and the payback in about 50 years as indicated by symbol 51.

A graph in FIG. 5a shows a renewable energy rate (based on a PPA) versus a conventional electric rate in kWh for Hennepin County relative to the renewable energies noted herein. For solar PV, the rate may be $0.383 per kWh versus the conventional electric rate of $0.079 per kWh, as indicated by bars 52 and 53, respectively. For wind, the rate may be $0.102 per kWh versus the conventional electric rate, as indicated by bars 54 and 53, respectively. For biomass gen and geothermal, the rates may be $0.218 and $0.145 as indicated by bars 55 and 56, respectively, versus the conventional electric rate as indicated by bar 53. For solar therm and biomass therm, the rates may be $32.30 and 17.26 as indicated by bars 57 and 59, respectively, versus the conventional gas rate of $10.16 as indicated by bar 58.

A graph in FIG. 5b shows a renewable energy rate (based on a PPA) versus a conventional electric rate in kWh for Chemung County relative to the renewable energies noted herein. For solar PV, the rate may be $0.382 per kWh versus the conventional electric rate of $0.139 per kWh, as indicated by bars 52 and 53, respectively. For wind, the rate may be $0.136 per kWh versus the conventional electric rate, as indicated by bars 54 and 53, respectively. For biomass gen and geothermal, the rates may be $0.220 and $0.161 as indicated by bars 55 and 56, respectively, versus the conventional electric rate as indicated by bar 53. For solar therm and biomass therm, the rates may be $32.70 and 18.10 as indicated by bars 57 and 59, respectively, versus the conventional gas rate of $12.88 as indicated by bar 58.

A graph in FIG. 5c shows a renewable energy rate (based on a PPA) versus a conventional electric rate in kWh for Chaves County relative to the renewable energies noted herein. For solar PV, the rate may be $0.232 per kWh versus the conventional electric rate of $0.077 per kWh, as indicated by bars 52 and 53, respectively. For wind, the rate may be $0.116 per kWh versus the conventional electric rate, as indicated by bars 54 and 53, respectively. For biomass gen and geothermal, the rates may be $0.307 and $0.138 as indicated by bars 55 and 56, respectively, versus the conventional electric rate as indicated by bar 53. For solar therm and biomass therm, the rates may be $21.53 and 22.57 as indicated by bars 57 and 59, respectively, versus the conventional gas rate of $10.53 as indicated by bar 58.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A renewable energy calculator comprising:
a financial model module;
a technology model module connected to an input of the financial model module; and
a scorecard module connected to an output of the financial model module.

2. The calculator of claim 1, further comprising:
a data source module connected to an input of the technology model; and
wherein the data source module is for providing energy data by region.

3. The calculator of claim 2, further comprising:
a data mapping module connected to an input of the data source module; and
wherein the data mapping module is for mapping energy data by region.

4. The calculator of claim 3, further comprising a renewable energy data module connected to an input of the data mapping module.

5. The calculator of claim 1, further comprising a finance information module connected to an input of the financial model module.

6. The calculator of claim 2, further comprising a customer information module connected to an input of the scorecard module.

7. The calculator of claim 6, wherein:
the customer information module is for providing customer data by size, location and/or business segment to the scorecard module; and
the scorecard module is for providing a renewable energy value by region and/or customer.

8. The calculator of claim 1, wherein:
an output of the scorecard module is for providing a list of customers targeted for renewable energy; and
a criterion for a customer to be targeted for renewable energy is one who can have renewable energy at a cost less than a cost of conventional energy.

9. The calculator of claim 2, wherein the technology model is for transforming data from the data source module into a renewable energy value by geographical region.

10. A method for calculating renewable energy targets comprising:
providing a financial model;
providing renewable energy data by region to the financial model; and
obtaining a scorecard from the financial model; and
wherein the scorecard is for providing an evaluation of renewable energies according to region.

11. The method of claim 10, further comprising:
obtaining customer information for the scorecard; and
providing a list of customers targetable for renewable energy projects.

12. The method of claim 11, further comprising:
determining costs of a renewable energy project by region from the financial model; and
evaluating one or more merits of selling renewable energy.

13. The method of claim 10, wherein the scorecard comprises renewable energy information relevant to a selectable region.

14. The method of claim 13, wherein the renewable energy relevant information comprises one or more of the following items:
conventional energy costs;
renewable energy costs;
heating degree days;
cooling degree days;
average air temperature;
mean earth temperature;
average wind speed;
biomass amount per unit area;
solar energy rate per unit area;
comparisons of renewable energy rates versus conventional energy rates;
government incentives; and
one or more other renewable energy items.

15. The method of claim 13, wherein the renewable energy relevant information comprises capital purchase benefit per an investment amount for one or more renewable energies per region.

16. The method of claim 13, wherein:
the renewable energy relevant information comprises a comparison of a renewable energy rate and a conventional energy rate for one or more renewable energies; and
the comparison of a renewable energy rate and a conventional energy rate for one or more renewable energies is a basis for a decision whether to sell the one or more renewable energies.

17. A renewable energy calculation system comprising:
a financial model module;
a technology model module connected to the financial model module; and
a scorecard module connected to the financial model module; and
wherein:
the technology model module is for providing renewable energy values; and
the scorecard module is for providing renewable energy values according to region relative to costs, financing, capital, and/or conventional energy cost rates.

18. The system of claim 17, further comprising:
a data source module connected to the technology model module; and
wherein the data source module is for providing energy data by region.

19. The system of claim 18, further comprising:
a data mapping module connected to the data source module; and
wherein the data mapping module is for obtaining renewable energy data from one or more sources outside of the calculation system and for mapping the renewable energy data relative to areas.

20. The system of claim 17, further comprising:
a customer information module connected to the scorecard module; and
wherein:
the scorecard module is for providing a list of customer prospects for renewable energy sales; and
the customer prospects are selected from regions where a cost of a unit of renewable energy is less than a cost of a unit conventional energy; and
the units of renewable energy and conventional energy are equivalent.
